(19) United States
(12) Patent Application Publication
(10) Pub. No.: US 2020/0333630 A1
(43) Pub. Date: Oct. 22, 2020

(54) IMAGING THE EYE TO DETECT ACCOMMODATION USING AN OPHTHALMIC LENS

(71) Applicant: Johnson & Johnson Vision Care, Inc., Jacksonville, FL (US)

(72) Inventors: Adam Toner, Jacksonville, FL (US); Donald Scott Langford, Melbourne, FL (US)

(21) Appl. No.: 16/388,698

(22) Filed: Apr. 18, 2019

(51) Int. Cl. G02C 7/02; G02C 7/04; G02C 7/08

(52) U.S. Cl. CPC G02C 7/024; G02C 7/083; G02C 7/04

(57) ABSTRACT

An ophthalmic lens having an electronic system for imaging at least a wearer's eye including a ciliary muscle and/or a lens to determine lens accommodation by propagating a sound pressure wave(s) into the eye and determining a relative position of the ciliary muscle from one or more detections of the partially reflected sound pressure wave(s) including, for example, amplitude and/or time and in other embodiments frequency. The ophthalmic lens includes at least one ultrasound module having at least one transducer such as a pair of transmit and receive transducers, a transceiver transducer or a plurality of transducers. The ultrasound module includes additional components for the creation and reception of the sound pressure wave(s). The ophthalmic lens may be a contact lens or an intraocular lens.

### BACKGROUND OF THE INVENTION

### 1. Field of the Invention

The present invention relates to a powered or electronic ophthalmic lens, and more particularly, to a powered or electronic ophthalmic lens having an ultrasound module for imaging a wearer's eye including a ciliary muscle and/or a lens to determine a level of lens accommodation and/or to collect data.

### 2. Discussion of the Related Art

As electronic devices continue to be miniaturized, it is becoming increasingly more likely to create wearable or embeddable microelectronic devices for a variety of uses. Such uses may include monitoring aspects of body chemistry, administering controlled dosages of medications or therapeutic agents via various mechanisms, including automatically, in response to measurements, or in response to external control signals, and augmenting the performance of organs or tissues. Examples of such devices include glucose infusion pumps, pacemakers, defibrillators, ventricular assist devices and neurostimulators. A new, particularly useful field of application is in ophthalmic wearable lenses and contact lenses. For example, a wearable lens may incorporate a lens assembly having an electronically adjustable focus to augment or enhance performance of the eye. In another example, either with or without adjustable focus, a wearable contact lens may incorporate electronic sensors to detect concentrations of particular chemicals in the precorneal (tear) film. The use of embedded electronics in a lens assembly introduces a potential requirement for communication with the electronics, for a method of powering and/or re-energizing the electronics, for interconnecting the electronics, for internal and external sensing and/or monitoring, and for control of the electronics and the overall function of the lens.

The human eye has the ability to discern millions of colors, adjust easily to shifting light conditions, and transmit signals or information to the brain at a rate exceeding that of a high-speed internet connection. Contact lenses currently are utilized to correct vision defects such as myopia (nearsightedness), hyperopia (farsightedness), presbyopia and astigmatism. However, properly designed lenses incorporating additional components may be utilized to enhance vision as well as to correct vision defects.

Conventional contact lenses are polymeric structures with specific shapes to correct various vision problems as briefly set forth above. To achieve enhanced functionality, various circuits and components have to be integrated into these polymeric structures. For example, control circuits, microprocessors, communication devices, power supplies, sensors, actuators, light-emitting diodes, and miniature antennas may be integrated into contact lenses via custom-built optoelectronic components to not only correct vision, but to enhance vision as well as provide additional functionality as is explained herein. Electronic and/or powered ophthalmic lenses may be designed to provide enhanced vision via zoom-in and zoom-out capabilities, or just simply modifying the refractive capabilities of the lenses. Electronic and/or powered contact lenses may be designed to enhance color and resolution.

The proper combination of devices could yield potentially unlimited functionality; however, there are a number of difficulties associated with the incorporation of extra components on a piece of optical-grade polymer. In general, it is difficult to manufacture such components directly on the lens for a number of reasons, as well as mounting and interconnecting planar devices on a non-planar surface. It is also difficult to manufacture to scale. The components to be placed on or in the lens need to be miniaturized and integrated onto just 1.5 square centimeters of a transparent polymer while protecting the components from the liquid environment on the eye. It is also difficult to make a contact lens comfortable and safe for the wearer with the added thickness of additional components.

In addition, because of the complexity of the functionality associated with a powered lens and the high level of interaction between all of the components comprising a powered lens, there is a need to coordinate and control the overall operation of the electronics and optics comprising a powered contact lens. Accordingly, there is a need for a system to control the operation of all of the other components based on physiological changes representing attempts to accommodate that is safe, low-cost, and reliable, has a low rate of power consumption and is scalable for incorporation into a contact lens. Accordingly, there exists a need for a means and method for detecting physiological changes representing attempts to accommodate.

There are several scenarios where there is a need for powered contact lenses to communicate during normal operation. Methods of detecting and changing lens state for presbyopia, commonly referred to as accommodation, may require the state of the left and right eye to be shared to determine if the lens focus should be changed. In each case, the independent state of each eye must be communicated so that the system controller can determine the required state of the variable lens actuator. There are other cases where it may enhance the user experience if the lens state (e.g., focus state) is changed in a coordinated fashion.

### SUMMARY OF THE INVENTION

In the human eye, the lens focuses the image projected from the cornea. The lens has the capability to change shape, and accordingly its degree of refraction, with the aid of the ciliary muscle. The ciliary muscle encircles the lens of the eye and is connected to the lens by ligaments called zonules. The most widely accepted theory of lens accommodation, the active altering of the lens to bring close objects into focus, is that the ciliary muscle either contracts or relaxes to change the shape of the lens. Thus, the ciliary muscle changes the focal point of the eye: when in its relaxed state the eye is focused on objects greater than 6 meters away and conversely, the ciliary muscle contracts or closes when the eye focuses on an object closer than 6 meters away. Accordingly, lens accommodation can be determined by measuring the change in relative position of either the ciliary muscle in its relaxed and contracted states, or the lens when the ciliary muscle is in its relaxed and contracted states, and comparing the displacement during accommodation to known anatomical thresholds.

Ultrasound diagnostic systems utilize the interaction of sound waves with biological tissue to produce cross-sectional images. For purposes of this disclosure, a high frequency sound pressure wave is directed through the iris toward the ciliary muscle. This wave undergoes partial reflection at the front and back boundary of the iris and the boundary of the ciliary muscle. In at least one embodiment, the time based amplitude of the of the sound pressure wave(s), based on the time lapse between when the sound pressure wave is propagated and when the partially reflected sound pressure wave is detected, is recorded. The position of the ciliary muscle relative to the transducer and iris are computed using the time of flight between various amplitude and sound velocity characteristics through the travelling media, e.g. aqueous humour, lens, and eye tissues generally. A high frequency sound pressure wave can also be directed to the lens of the eye. This wave undergoes partial reflection at the anterior boundary of the lens. The time of flight of the sound pressure wave, based on the time that the ‘reflection’ is detected, is recorded and the positions of the lens boundaries are computed using sound velocities through the travelling media, e.g. aqueous humour, lens, and eye tissues generally, and time taken to receive the echoes. A similar approach can be used in an intraocular lens where the boundaries may be the intraocular lens, the iris, and/or the ciliary

In at least one embodiment, an ophthalmic lens is configured for imaging of a wearer's eye including an iris, a ciliary muscle and/or a lens and includes: at least one ultrasound module including at least two transducers orientated such that when a sound pressure wave is propagated, the sound pressure wave travels towards the wearer's ciliary muscle and/or the lens and oriented to receive sound pressure waves reflected from the ciliary muscle and/or the lens; a system controller in electrical communication with the at least one ultrasound module, the system controller configured to provide at least one control signal to the at least one ultrasound module and receive at least one corresponding data signal from the at least one ultrasound module, and the controller configured to determine a relative position, shape, and/or state of the wearer's ciliary muscle and/or lens based on data signals produced by the at least one ultrasound module in response to at least one received sound pressure wave; an actuator in electrical communication with the system controller configured to perform a function in response to at least one control signal from the system controller; and a timing circuit in electrical communication with the system controller. In a further embodiment, the ophthalmic lens includes a memory in communication with the system controller and/or the actuator; wherein the actuator is configured to store data based on each sample taken in the memory. In a further embodiment to any of the above embodiments, the ophthalmic lens includes a communications module in electrical communication with the system controller. In a further embodiment to any of the above embodiments, the ophthalmic lens includes a power source in electrical communication with the system controller and the timing circuit. In a further embodiment to any of the above embodiments, the ophthalmic lens includes a data storage in electrical communication with the system controller, the data storage storing preset values.

In a further embodiment to the any of the above embodiments, the at least one ultrasound module includes a plurality of ultrasound modules distributed around the ophthalmic lens. In a further embodiment to any of the embodiments of the previous paragraph, the at least two transducers are four transducers and includes a first transmit transducer, a second transmit transducer, a first receive transducer, and a second receive transducer.

In a further embodiment to any of the above embodiments, each ultrasound module includes a processor in electrical communication with the system controller; a first transceiver and a second transceiver, each transceiver having a switch in electrical communication with the processor; at least one transmit path having an oscillator in electrical communication with the processor, a burst generator in electrical communication with the oscillator and the processor, a transmit driver in electrical communication with the burst generator configured to receive a burst signal from the burst generator, the transmit driver drives one of the two transducers when connected through the switch; and at least one receive path having a receive amplifier in electrical communication with the one of at least two transducers through the switch and configured to amplify an output of the one of the two transducers, an analog signal processor in communication with the receive amplifier and the processor; and wherein the processor configured to control the switch and an operation mode of the ultrasound module between transmit and receive. In a further embodiment to the previous embodiment, each transceiver is tuned to different frequencies.

In a further embodiment to any of the above embodiments, one of the at least two transducers in the at least one ultrasound module is configured to transmit and receive the sound pressure wave at a frequency in a range of 5 to 20 MHz. or one of the at least two transducers in the at least one ultrasound module is configured to transmit and receive the sound pressure wave at a frequency above 20 MHz.

In at least one embodiment, a method of imaging an eye to detect lens accommodation using an ophthalmic lens having at least one ultrasound module having at least one transducer and a processor configured to perform a clock function, a system controller in electrical communication with the at least one ultrasound module, and a memory in electrical communication with the system controller, the method including: propagating into the eye a first sound pressure wave at a predetermined frequency by one of the at least one transducer of the ultrasound module; transmitting a first data signal to the system controller representing a time, an amplitude, and/or a frequency of at least one first received sound pressure wave detected by at least one of the at least one transducer of the ultrasound module; recording the first data signal in the memory by the system controller; propagating into the eye a second sound pressure wave at a predetermined frequency by one of the at least one transducer of the ultrasound module; transmitting a second data signal to the system controller a time, an amplitude, and/or a frequency of at least one second received sound pressure wave detected by at least one of the at least one transducer of the ultrasound module; setting a position distance based on the relationship of the difference between the first data signal and the second data signal; storing the second data signal by the system controller in memory; comparing the position distance to a distance threshold by the system controller. In a further embodiment to the previous embodiment, the method further including driving an actuator when the position distance reaches the distance threshold correlating to distance displaced by a ciliary muscle during accommodation and/or driving an actuator when the position distance reaches the distance threshold correlating to distance displaced by a lens during accommodation. In a further embodiment to the previous embodiments of this paragraph, the method further including propagating the first sound pressure wave and the second sound pressure wave at a predetermined sampling interval. In a further embodiment to the previous embodiments of this paragraph, the method further including analyzing a series of times of flight in the data signals with time-frequency analysis.

In at least one embodiment, a method of imaging an eye to detect accommodation using an ophthalmic lens system including a first ophthalmic lens and a second ophthalmic lens, each ophthalmic lens having at least one ultrasound module having two transducers tuned to different frequencies and a processor configured to perform a clock function, a system controller in electrical communication with the communications module and the at least one ultrasound module, and a data storage in electrical communication with the system controller, the method including: propagating into the eye a first sound pressure wave at a predetermined frequency by each of the two transducers of the ultrasound module; transmitting a first data signal to the system controller representing a time, an amplitude, and/or a frequency of at least one first received sound pressure wave detected by each of the two transducers of the ultrasound module based in part on a signal from the timing circuit; setting a first position from the relationship of the first data signal using a predefined constant; recording the first position in the data storage; propagating into the eye a second sound pressure wave at a predetermined frequency by each of the two transducers of the ultrasound module; transmitting a second data signal to the system controller representing a time, an amplitude, and/or a frequency of at least one received sound pressure wave detected by each of the two transducers of the ultrasound module by the timing circuit; setting a second position from the relationship of the second data signal using the predefined constant; recording the second position in the data storage; determining a displacement based on the difference between the first position and the second position; and driving the actuator when the displacement reaches a predetermined threshold. In a further embodiment to the previous embodiment, the predetermined threshold correlates to an eye having presbyopia. In a further embodiment to the previous embodiments of this paragraph, the first ophthalmic lens is a master and the second ophthalmic lens is a subordinate, each ophthalmic lens includes a communications module, the method further including: setting a binary accommodation indicator in the data storage on the first lens where 1 corresponds to accommodation; establishing a communications link between the communications modules on the ophthalmic lenses; transmitting a message encoding the binary accommodation indicator by the communications module on the first ophthalmic lens; decoding the received message by the communications module on the second ophthalmic lens; and driving the actuator on the second ophthalmic lens when the received binary accommodation indicator equals 1.

In a further embodiment to any of the above embodiments, the ophthalmic lens is a contact lens. In a further embodiment to any of the embodiments in the previous paragraphs of this section, the ophthalmic lens is an intraocular lens.

In at least one embodiment, a method of imaging an eye to detect accommodation using an ophthalmic lens having at least one ultrasound module having at least two transducers tuned to a first and a second frequency and a processor, a system controller in electrical communication with the at least one ultrasound module, and a memory in electrical communication with the system controller having preset values, the method including: propagating into the eye a first sound pressure wave by each of the at least two transducers; detecting a partially reflected sound pressure wave by each of the at least two transducers; storing a first time of flight corresponding to time lapsed from propagating the first sound pressure wave to detecting the partially reflected sound pressure wave by each of the at least two transducers to memory; propagating into the eye a second sound pressure wave by each of the at least two transducers; detecting a partially reflected sound pressure wave by each of the at least two transducers; storing a second time of flight corresponding to time lapsed from propagating the first sound pressure wave to detecting the partially reflected sound pressure wave by each of the at least two transducers to memory; determining at least a first and a second absolute position by the system controller from the relationship of the first time of flight and the second time of flight for each of the at least two transducers to a predefined constant representative of a speed of sound; driving the actuator when both the first absolute position and the second absolute position reach predetermined thresholds.

### BRIEF DESCRIPTION OF THE DRAWINGS

The foregoing and other features and advantages of the invention will be apparent from the following, more particular description of preferred embodiments of the invention, as illustrated in the accompanying drawings.

FIGS. 1A-4B illustrate detecting accommodation in the normal human eye (shown as a cross-section) by tracking displacement of the ciliary muscle, lens, and/or other eye anatomy features in accordance with at least four embodiments of the present invention. FIGS. 2C and 2D illustrate an example of an amplitude versus time waveform for reflected sound pressure waves as the emitted sound pressure wave travels through the eye.

FIG. 5A illustrates a contact lens having at least one ultrasound module in accordance with at least one embodiment of the present invention.

FIG. 5B illustrates a contact lens having at least one ultrasound module, a system controller, and a timing circuit in accordance with at least one embodiment of the present invention.

FIG. 5C illustrates a contact lens having at least one ultrasound module, a system controller, a timing circuit, and a communications module in accordance with at least one embodiment of the present invention.

FIG. 5D illustrates a contact lens having at least one ultrasound module and a system controller having a register in accordance with at least one embodiment of the present invention.

FIG. 6 illustrates an ultrasound module in accordance with at least one embodiment of the present invention.

FIG. 7 illustrates an ultrasound module with one transducer and a multiplexer in accordance with at least one embodiment of the present invention.

FIG. 8 illustrates an ultrasound module with two transmit transducers and two receive transducers in accordance with at least one embodiment of the present invention.

FIG. 9 illustrates an ultrasound module with a charge pump and an envelope detector in accordance with at least one embodiment of the present invention.

FIG. 10 illustrates an ultrasound module with one transducer and a multiplexer in accordance with at least one embodiment of the present invention.

FIG. 11 illustrates an ultrasound module with one transducer and a multiplexer in accordance with at least one embodiment of the present invention.

FIG. 12 illustrates a diagrammatic representation of an electronic insert, including a pair of transducers, for a powered contact lens in accordance with at least one embodiment of the present invention.

FIG. 13 illustrates a diagrammatic representation of an electronic insert, including a transducer, for a powered contact lens in accordance with at least one embodiment of the present invention.

FIG. 14 illustrates a diagrammatic representation of evenly spaced ultrasound modules/transducers in accordance with at least one embodiment of the present invention.

FIG. 15 illustrates an ultrasound module with a plurality of transmit/receive transducer pairs or transceiver transducers in accordance with at least one embodiment of the present invention.

FIG. 16 illustrates a method in accordance with at least one embodiment of the present invention.

FIG. 17 illustrates a method in accordance with at least one embodiment of the present invention.

### DETAILED DESCRIPTION OF THE EMBODIMENTS

Conventional contact lenses are polymeric structures with specific shapes to correct various vision problems as briefly set forth above. To achieve enhanced functionality, various circuits and components may be integrated into these polymeric structures. For example, control circuits, microprocessors, communication devices, power supplies, sensors, ultrasound modules, and miniature antennas may be integrated into contact lenses via custom-built optoelectronic components to not only correct vision, but to enhance vision as well as provide additional functionality as is explained herein. Electronic and/or powered contact lenses may be designed to provide enhanced vision via zoom-in and zoom-out capabilities, or just simply modifying the refractive capabilities of the lenses. Electronic and/or powered contact lenses may be designed to enhance color and resolution.

The powered or electronic ophthalmic lens in at least one embodiment includes the necessary elements to monitor the wearer with or without elements to correct and/or enhance the vision of the wearer with one or more of the above described vision defects or otherwise perform a useful ophthalmic function. The electronic ophthalmic lens may have a variable-focus optic lens, an assembled front optic embedded into an ophthalmic lens or just simply embedding electronics without a lens for any suitable functionality. The electronic lens of the present invention may be incorporated into any number of contact lenses as described above or intraocular lenses. Intraocular lenses may also incorporate the various components and functionality described herein. However, for ease of explanation, the disclosure will focus on an electronic contact lens intended for single-use daily disposability.

The present invention may be employed in a powered contact lens having an electronic system, which actuates a variable-focus optic or any other device or devices configured to implement any number of numerous functions that may be performed including data collection. The electronic system includes one or more batteries or other power sources, power management circuitry, one or more sensors, clock generation circuitry, control algorithms and circuitry, and lens driver circuitry. The complexity of these components may vary depending on the required or desired functionality of the lens.

In at least one embodiment, supplemental control of an electronic or a powered contact lens may be accomplished through a manually operated external device that communicates with the lens through radio frequency (RF) or ultrasonic communication, such as a hand-held remote unit, a phone, a storage container, spectacles, glasses, or a cleaning box. For example, an external device may wirelessly communicate using RF or ultrasound with the powered lens based upon manual input from the wearer. Alternatively, control of the powered contact lens may be accomplished via feedback or control signals directly from the wearer. For example, ultrasound modules built into the lens may include a transmit ultrasound transducer and at least one receive ultrasound transducer, a combination transmit/receive ultrasound transducer, or a combination passive transmit/receive backscatter ultrasound transducer. In at least one embodiment, the powered contact lens may change operation state such as change focus of the contact lens. A further alternative is that the wearer has no control over operation of the powered contact lens.

Because of the complexity of the functionality associated with a powered lens and the high level of interaction between all of the components comprising a powered lens, there is a need to coordinate and control the overall operation of the electronics and optics comprising a powered contact lens. Accordingly, there is a need for a system to control the operation of all of the other components and provide communication between a pair of contact lenses that is low-cost and reliable, has a low rate of power consumption, and is scalable for incorporation into a contact lens.

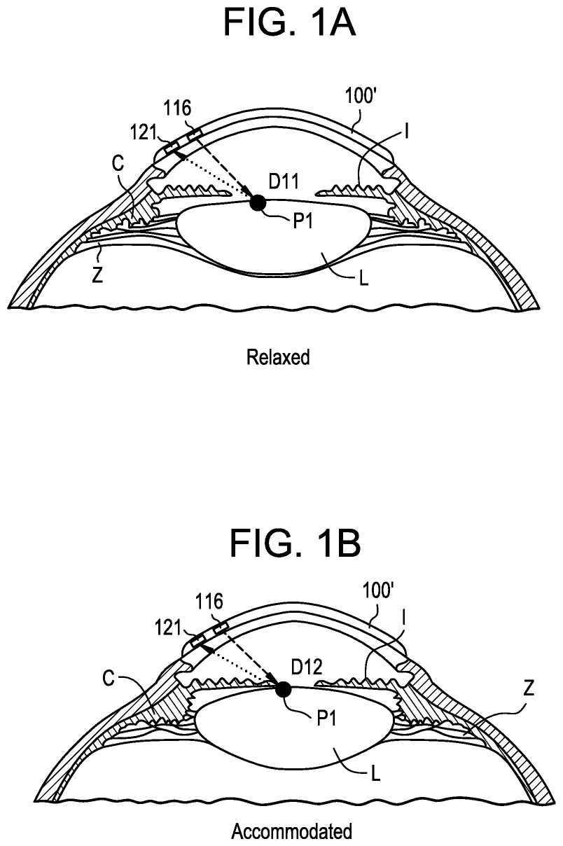

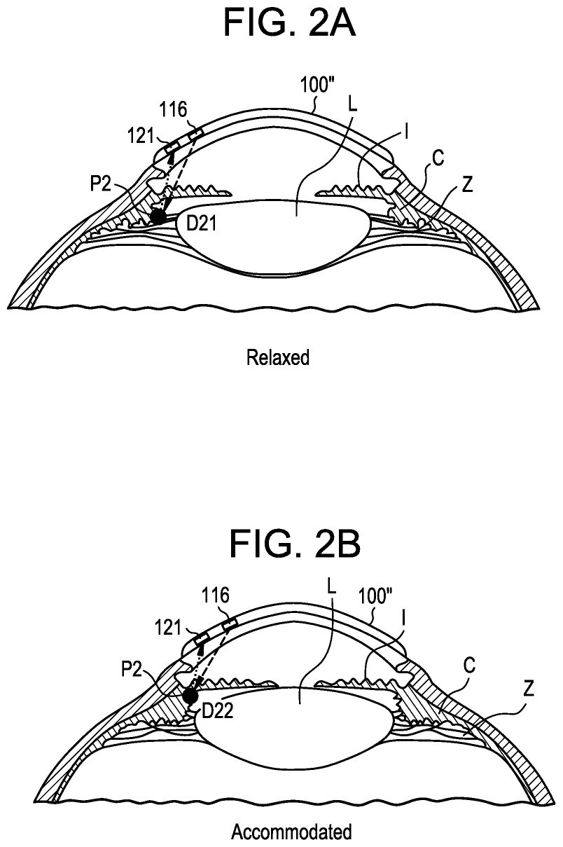

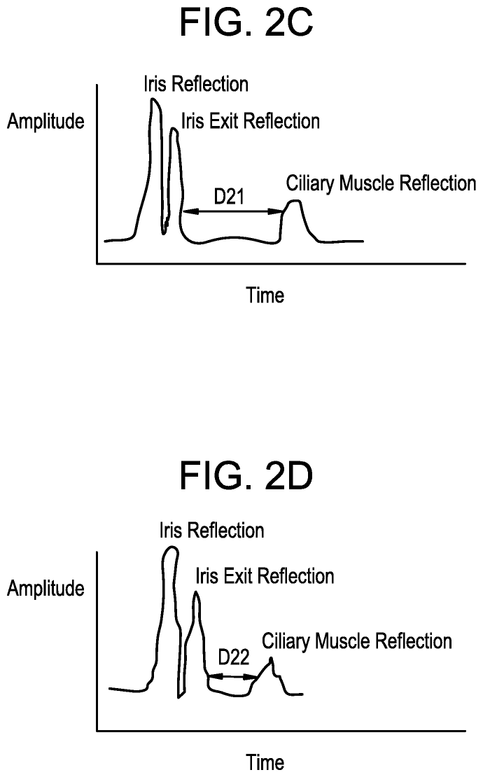

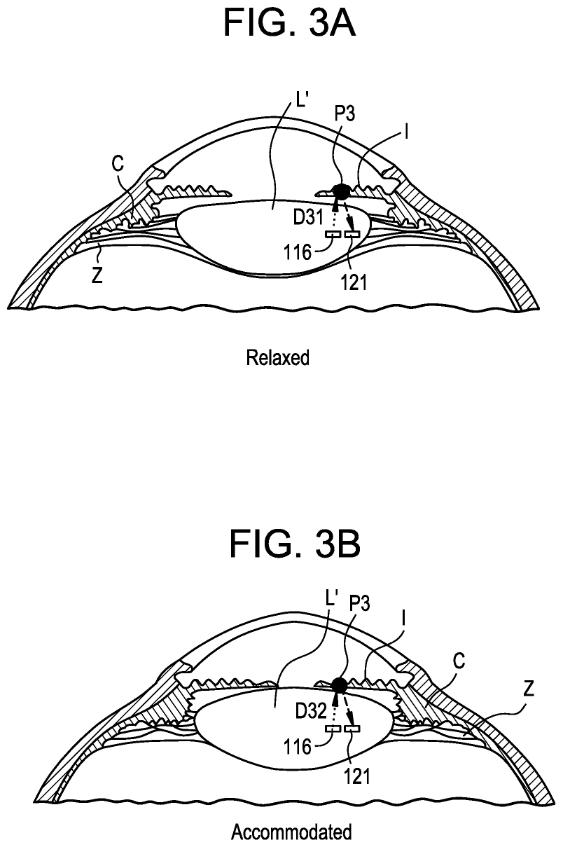

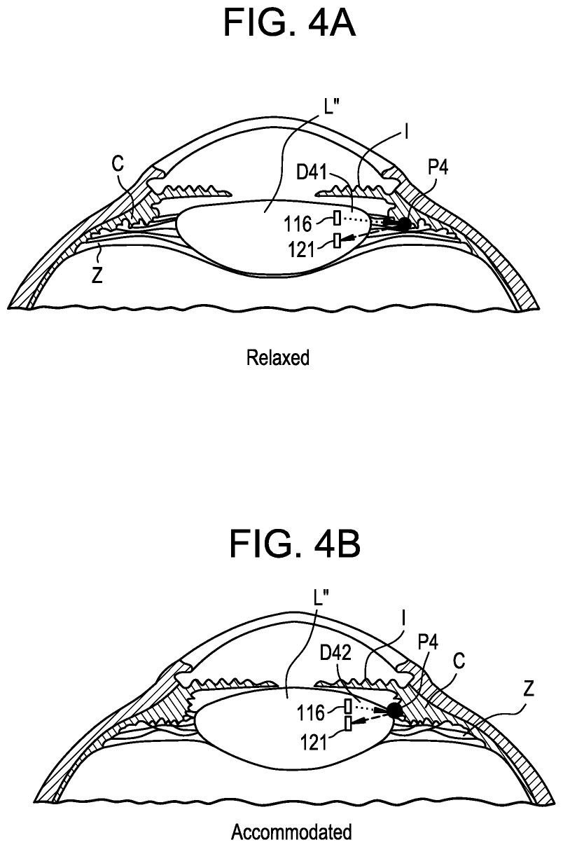

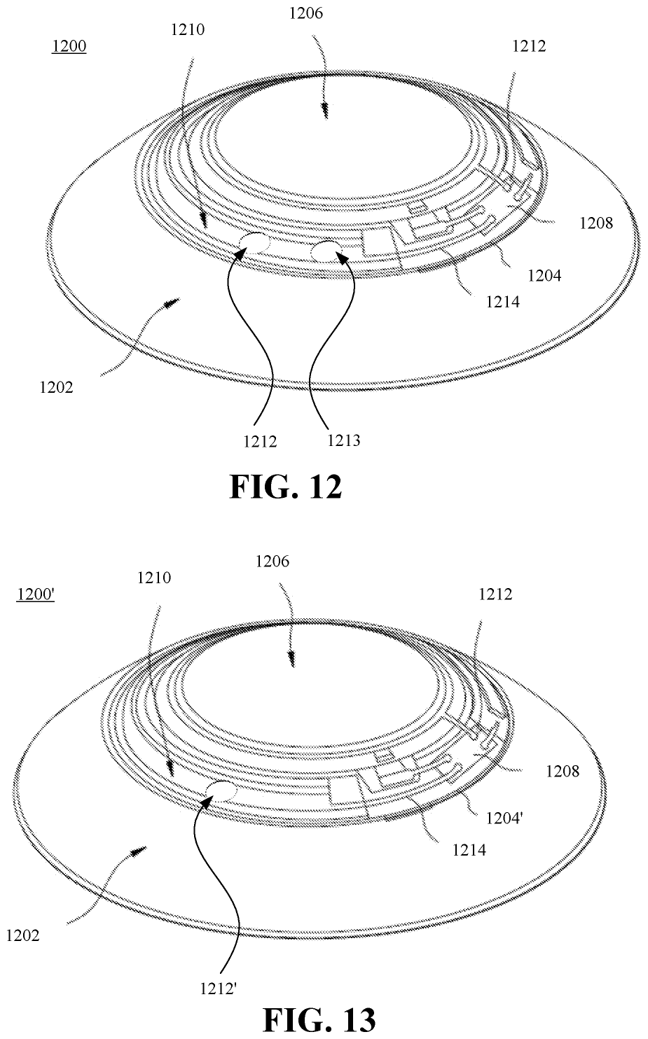

FIGS. 1A-4B are illustrations of measuring displacement with transducers of either or both of a ciliary muscle C and the lens L as a result of contraction of the ciliary muscle C and/or detensioning of the zonules Z according to at least two embodiments of the invention. The illustrated placement of the transducers 116, 121 is for illustrating how one transducer 116 transmits a sound pressure wave that reflects from a point in the eye anatomy back to the second transducer 121. Depending on the configuration chosen for the transducers, the transducers may interact with the ciliary muscle C, the zonules Z, the lens L, the iris I and/or the surfaces of these anatomy features. Additionally, the transducers illustrated in FIGS. 1A and 2A can be combined in one contact lens 100′/100″, while the transducers illustrated in FIGS. 3A and 4A can be combined in one intraocular lens. FIG. 12 illustrates an example of one placement of the transducers 116, 121 on a contact lens 1200 with a pair of transducers 1212, 1213, which will be described later in this specification, placed outside a variable lens 1206. FIGS. 1A, 2A, 3A, and 4A illustrate the eye in an unaccommodated state, while FIGS. 1B, 2B, 3B, and 4B illustrate the eye in an accommodated state. Physiological indicators of lens accommodation include the position of the ciliary muscle C and/or the position of the lens L. When the lens L is in its accommodated state, the ciliary muscle C closes the distance between the ciliary muscle C and the lens L as illustrated in FIGS. 1B, 2B, 3B, and 4B. These figures illustrate a target P1, P2, P3, or P4 at which the sound pressure wave is aimed and whose reflected sound pressure wave in at least one embodiment is the end point of a data series or in another embodiment is the time of flight measurement of interest. As referenced in other parts of this disclosure, the resulting data from the reflected sound pressure waves may be subjected to frequency analysis. Thus, the amplitude, the frequency, and/or the time lapse between when the sound pressure wave is propagated by the ultrasound transducer and when the partially reflected sound pressure wave is detected by the ultrasound transducer can be used to determine displacement of the ciliary muscle C and/or the lens L, and accordingly the level of lens accommodation. In an alternative embodiment, the time measurements are analyzed in the frequency domain, for example to determine the existence of any patterns by recording a data series representing a plurality of amplitude measurements versus time as illustrated in FIGS. 2C and 2D that can be compared to each other to determine if different measurements are present representing that a change has occurred. As illustrated in FIGS. 2C and 2D, respective distance and/or time of flight between the iris I and the ciliary muscle C can be detected based on their respective reflections (see, e.g., D21 and D22).

FIGS. 1A-2B illustrate a contact lens 100′, 100″ having a transmit transducer 116 and a receive transducer 121. As discussed in this disclosure, the transducers may take a variety of configurations. FIGS. 1A and 1B illustrate where the target P1 is a spot on the lens L of the eye and D11 and D12 are the times of flight between the transducers 116, 121 and the lens L. FIGS. 2A and 2B illustrate where the target P2 is a spot on the ciliary muscle C and how the sound pressure wave will travel through the iris I. The sound pressure wave in both of these embodiments is emitted by the transmit transducer 116 and a reflection(s) of that sound pressure wave is received by the receive transducer 121. FIGS. 2C and 2D illustrate how an amplitude versus time waveform for FIGS. 2A and 2B, respectively, might look like depending on the resolution of the system. As the sound pressure wave passes through a boundary, there is a portion of it that is reflected. FIGS. 2C and 2D illustrate a reflection occurring when the sound pressure wave contacts the iris I, when the sound pressure wave exits the iris I, and a reflection when the sound pressure wave contacts the ciliary muscle C. The time difference between D21 and D22 between the iris exit reflection and the ciliary muscle reflection is representative of the distance between the iris I and the ciliary muscle C. If the time difference (or the distance if the time is converted) is above a threshold, then the eye has changed from a relaxed state to an accommodated state or vice versa. Alternatively, D21 and D22 could be the times of flight between the transducers 116, 121 and the ciliary muscle C. Based on this disclosure, it should be understood that different barriers will provide similar waveforms that can be used for analysis other than or in addition to any use of time of flight.

FIGS. 3A-4B illustrate an intraocular lens L′, L″ having a transmit transducer 116 and a receive transducer 121. As discussed in this disclosure, the transducers may take a variety of configurations. FIGS. 3A and 3B illustrate where the target P3 is a spot on the iris I and D31 and D32 are the times of flight between transducers 116, 121 and the iris I. FIGS. 4A and 4B illustrate where the target P4 is a spot on the ciliary muscle C and how the sound pressure wave will travel through the iris I and D41 and D42 are the times of flight between transducers 116, 121 and the ciliary muscle C. The sound pressure wave in both of these embodiments is emitted by the transmit transducer 116 and a reflection(s) of that sound pressure wave is received by the receive transducer 121. Alternatively, the times of flight measured could be to the edge of the intraocular lens L′ or the edge of the intraocular lens L″ to the ciliary muscle C.

The distance traveled by the sound pressure wave and the time of flight are related by a constant specific to the media through which the sound pressure wave travels. In at least one embodiment, the constant corresponds to the speed of sound in the aqueous and vitreous humour. The distance to the ciliary muscle can be measured based on the relationship of the time of flight to the speed of sound in eye tissue (typically around 1540 meters/second) divided by two since the ultrasound pulse travels from the eye surface to the ciliary muscle and back. In a normal eye a sound pressure wave would traverse the distance from its surface through the iris to the ciliary muscle and back in roughly 1.3 to 2.6 microseconds. The displacement of the ciliary muscle during accommodation is in the range of 140 micrometers and the imaging frequency required to resolve this change is variable from approximately 5 to 20 MHz where approximately allows for additional variance in manufacturing tolerances along with general variances from these frequencies. In an alternative embodiment, at least one transducer is configured to transmit and/or receive a sound pressure wave at a frequency above approximately 20 MHz. In an alternative embodiment, the full time of flight is used to provide a larger differential when comparing distances and/or time.

In at least one alternative embodiment, the relative position of the lens is used to determine accommodation. When the lens is relaxed, the distance from the surface of the eye to the lens is greater than when the lens is accommodated. The speed of sound in the lens is approximately 9% higher than in the aqueous humour thus providing a reflective boundary to measure lens position. The distance from the surface of the eye to the lens can be sampled to determine displacement. The optic lens in a normal eye is displaced around 200 micrometers in its accommodated state. Lens displacement in an eye having presbyopia, characterized by a thickening of the optical lens, is significantly smaller than in a normal lens, around 50 micrometers. The imaging frequency required to resolve displacement of the presbyopic lens during accommodation is on the order of 40 MHz.

In at least one further alternative embodiment the contact lens is configured to image both the lens and the ciliary muscle to determine accommodation such as a combination of FIGS. 1A-2B. In at least one embodiment as depicted in FIGS. 1A and 1B, a first pair of ultrasound transducers, a transmit transducer and a receive transducer, is used to determine the relative position P1 of the lens and a second pair of ultrasound transducers is used to determine the relative position P2 of the ciliary muscle to the contact lens. In at least one embodiment as depicted in FIGS. 3A-4B, a first pair of ultrasound transducers is used to determine the relative position P3 of the iris to the intraocular lens and a second pair of ultrasound transducers is used to detect the relative position P4 of the ciliary muscle relative to the second pair of transducers. Transducers having the structure discussed in connection with the different ultrasound modules. In at least one further embodiment, an actuator is configured to perform a predefined function when the relative position of either or both of the ciliary muscle and the lens satisfies predefined conditions or alternatively to store data provided by a system controller.

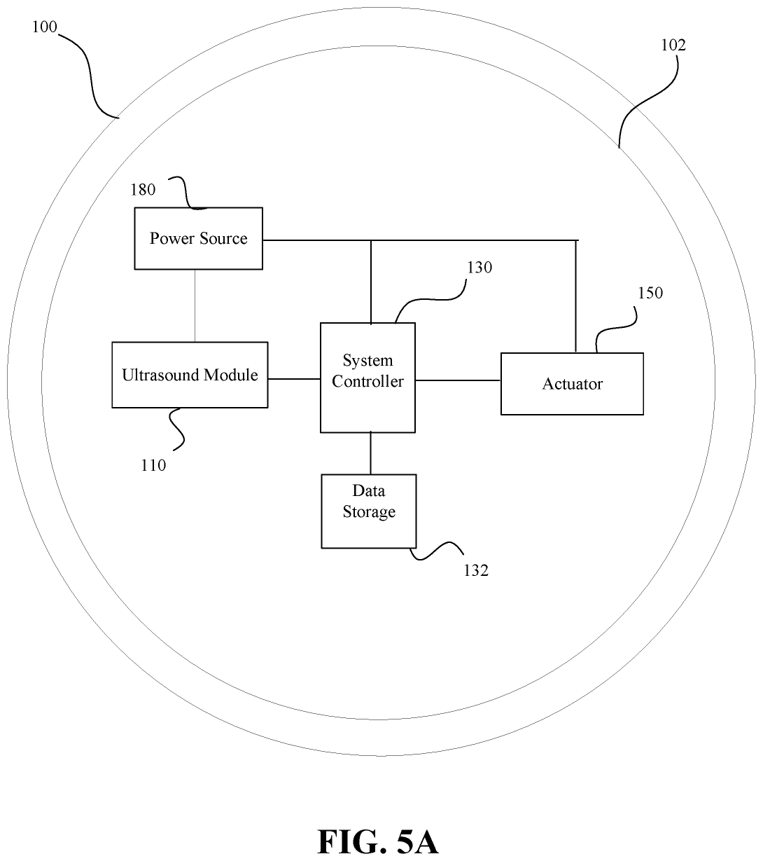

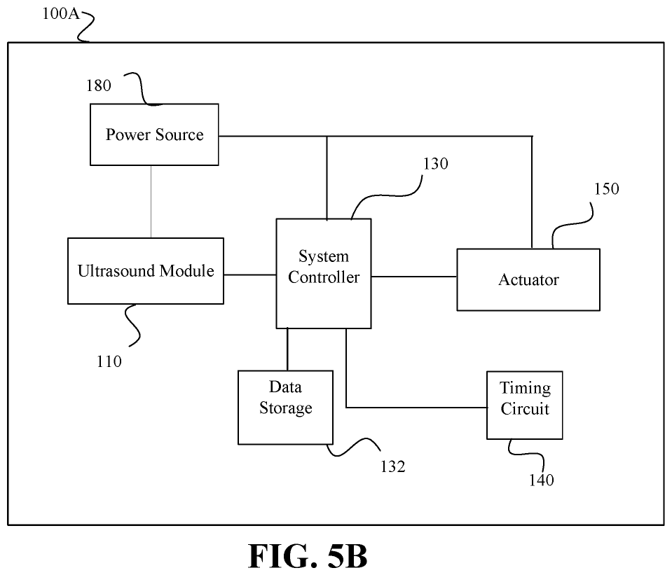

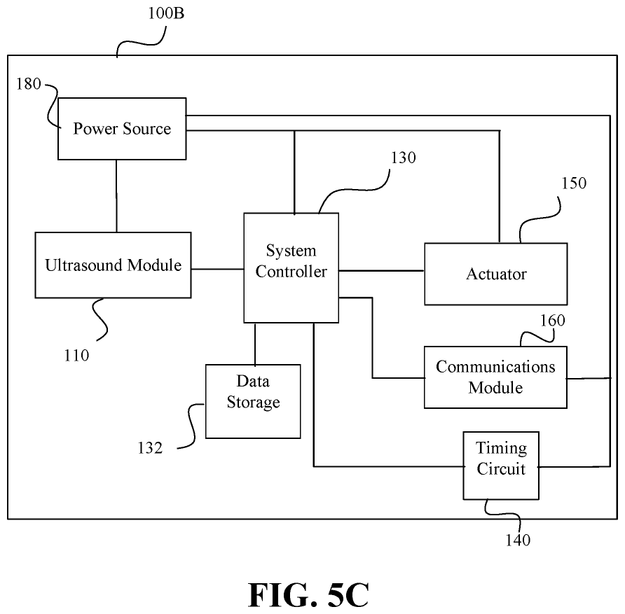

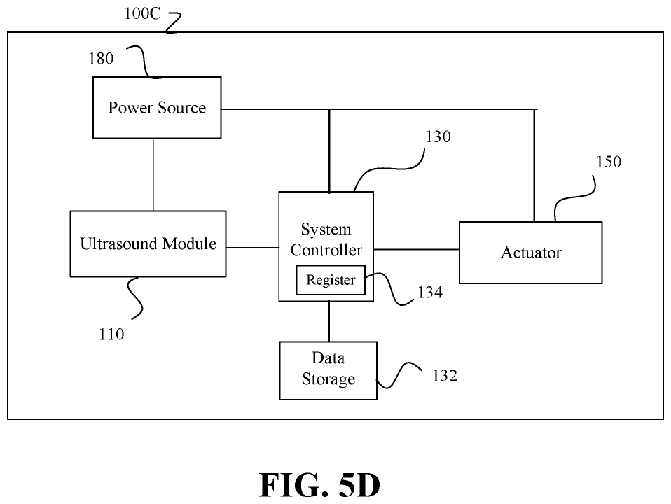

FIGS. 5A-11 and 15 illustrate different embodiments according to the invention that include a system controller 130 connected to an ultrasound module (collectively referred to as 110), a timing circuit 140, and an actuator 150 that are on a contact lens 100. The ultrasound module 110 may take a variety of forms including distinct transmit and receive transducers or a shared transmit/receive transducer. Depending on a particular implementation, there may be multiple ultrasound modules 110 and/or multiple transducers connected to at least one ultrasound module 110 present on the contact lens to facilitate particular functionality for the contact lens. The actuator 150 is representative of, for example, lens accommodation components, data collection components, data monitoring components, and/or functional components such as an alarm.

The system controller 130 in at least one embodiment uses at least one predetermined threshold for interpreting the output of the ultrasound module 110. In another embodiment, the system controller 130 makes use of at least one template (or pattern) to which a series of outputs of the ultrasound module 110 are compared against to determine whether the threshold is being met, exceeded or less than resulting in the threshold being satisfied. In at least one embodiment as illustrated in FIG. 5A, the system controller 130 is in electrical communication with a data storage 132 that stores the threshold(s). In at least one embodiment, the data storage 132 stores at least some of the previous measurements relating to the ciliary muscle's relative locations and/or the lens' relative locations. Examples of data storage 132 include memory such as persistent or non-volatile memory, volatile memory, and buffer memory, a register(s), a cache(s), programmable read-only memory (PROM), programmable erasable memory, magneto resistive random access memory (RAM), ferro-electric RAM, and flash memory, and polymer thin film ferroelectric memory. In an alternative embodiment, the output(s) of the ultrasound module 110 to the system controller 130 is converted by the system controller 130 into data (or a signal(s)) for control of the actuator 150. In an alternative embodiment, the system controller 130 interprets the output of the ultrasound module 110 using a predefined protocol. In at least one embodiment, constants, e.g. speed of sound in the eye, distance displaced by the ciliary muscle and/or the lens during accommodation, are stored in the data storage 132. In at least one embodiment, information stored in the data storage 132 corresponds to both a healthy eye and an eye having presbyopia. In other alternative embodiments, the data storage 132 may store instead or in addition information for other conditions. In at least one embodiment there is a register included in the system controller 130 or the data storage 132 to store recent measurements, for example that might be used as part of a pattern analysis or comparison purposes.

FIG. 5A illustrates a system on a contact lens 100 having an electro-active region 102 with an ultrasound module 110, a system controller 130, an actuator 150, and a power source 180. In at least one further embodiment, the electro-active region 102 includes an electronics ring around the contact lens 100 on which the electronics are located. The ultrasound module 110 in at least one embodiment has two-way communication with the system controller 130. The actuator 150 receives an output from the system controller 130. In at least one alternative embodiment, the actuator 150 is omitted from one or more of the illustrated embodiments in this disclosure.

The actuator 150 may include any suitable device for implementing a specific function based upon a received command signal from the system controller 130. For example, the system controller 130 may enable the actuator 150 to change focus of the contact lens, provide an alert to the wearer such as a light (or light array) to pulse a light into the wearer's retina (or alternatively across the lens), or to log data regarding the state of the wearer. Further examples of the actuator 150 acting as an alert mechanism include an electrical device; a mechanical device including, for example, chemical release devices with examples including the release of chemicals to cause an itching, irritation or burning sensation, and acoustic devices; a transducer providing optic zone modification of an optic zone of the contact lens such as modifying the focus and/or percentage of light transmission through the lens; a magnetic device; an electromagnetic device; a thermal device; an optical coloration mechanism with or without liquid crystal, prisms, fiber optics, and/or light tubes to, for example, provide an optic modification and/or direct light towards the retina; an electrical device such as an electrical stimulator to provide a mild retinal stimulation or to stimulate at least one of a corneal surface and one or more sensory nerves of the cornea; or any combination thereof. In an alternative embodiment, the actuator 150 sends an alert to an external device using, for example a forward-facing ultrasound module 110. The actuator 150 receives a signal from the system controller 130 in addition to power from the power source 180 and produces some action based on the signal from the system controller 130. For example, if the output signal from the system controller 130 occurs during one operation state, then the actuator 150 may alert the wearer that a medical condition has arisen or the contact lens is ending/nearing its useful life and/defective. In an alternative embodiment, the actuator 150 delivers a pharmaceutical product to the wearer in response to an instruction from the system controller 130. In an alternative embodiment, the signal outputted by the system controller 130 during another operation state, then the actuator 150 will record the information in memory for later retrieval. In a still further alternative embodiment, the signal will cause the actuator to alarm and store information. In an alternative embodiment, the system controller 130 stores the data in the memory (e.g., data storage 132 in other embodiments) associated with the system controller 130 and does not use the actuator 150 for data storage and in at least one embodiment, the actuator 150 is omitted. As set forth above, the powered lens of the present invention may provide various functionality; accordingly, one or more actuators may be variously configured to implement the functionality.

FIG. 5A also illustrates a power source 180, which supplies power for numerous components in the system. The power may be supplied from a battery, energy harvester, or other suitable means as is known to one of ordinary skill in the art. Essentially, any type of power source 180 may be utilized to provide reliable power for all other components of the system. In an alternative embodiment, communication functionality is provided by an energy harvester that acts as the receiver for the time signal, for example in an alternative embodiment, the energy harvester is a photovoltaic cell, a photodiode, or a radio frequency (RF) receiver, which receives both power and a time-base signal (or indication). In a further alternative embodiment, the energy harvester is an inductive charger, in which power is transferred in addition to data such as RFID. In one or more of these alternative embodiments, the time signal could be inherent in the harvested energy, for example N*60 Hz in inductive charging or lighting.

FIG. 5B illustrates a system on a contact lens 100A having an ultrasound module 110, a system controller 130, an actuator 150, and a power source 180. The ultrasound module 110 in at least one embodiment has two-way communication with the system controller 130. The actuator 150 receives an output from the system controller 130.

The timing circuit 140 provides a clock function for operation of the contact lens 100A. As illustrated the timing circuit 140 is connected to the system controller 130. In at least one embodiment, the timing circuit 140 drives the system controller 130 to send a signal to the ultrasound module 110 to perform a function based on a sampling time interval, which in at least one embodiment is variable based on the output from the ultrasound module 110 to the system controller 130. In an alternative embodiment, the timing circuit 140 is part of the system controller 130.

Based on this disclosure, it should be appreciated that in addition to the presence of the ultrasound module 110 on the contact lens 100 that additional sensors may be included as part of the contact lens to monitor characteristics of the eye and/or the lens. In at least one embodiment, at least a portion of the actuator 150 is consolidated with the system controller 130.

FIG. 5C illustrates another contact lens 100B that adds a communications module 160 for facilitating wireless communication with another device, e.g. a second contact lens to the embodiment illustrated in FIG. 5B.

A communications module 160 on each contact lens being worn by a user permits two-way communication to take place between the contact lenses. In a further or alternative embodiment, the contact lens(es) communicate with an external device. The communications module 160 may include transmitters, receivers, radio frequency (RF) transceivers, antennas, interface circuitry for photosensors, and associated or similar electronic components. A communication channel (or link) between the contact lenses may include RF transmissions at the appropriate frequency and power with an appropriate data protocol to permit effective communication between the contact lenses. The communications module 160 may be configured for two-way communication with the system controller 130. The communications module 160 may contain filtering, amplification, detection, and processing circuitry as is common for establishing a communications link. In an embodiment involving RF, the communications module 160 would be tailored for an electronic or powered contact lens, for example the communication may be at the appropriate frequency, amplitude, and format for reliable communication between eyes, low power consumption, and to meet regulatory requirements. The communications module 160 may work in the RF bands, for example 2.4 GHz, or may use light for communication. Information received by the communications module 160 is an input to the system controller 130. The system controller 130 may also transmit data from, for example, the ultrasound module 110 to the communications module 160, which then transmits data over the communication link to the other contact lens or possibly an external device. In an alternative embodiment, the contact lenses use an ultrasound module to establish the communication link between the contact lenses.

Considerations for the choice of wireless communication protocol include size and power consumption. In embodiments the communications module 160 is configured for communicating using encoded ultrasound pressure waves, the communications module 160 may be the ultrasound modules 100 discussed in this disclosure. In these embodiments, it is understood that the communications module 160 and ultrasound module(s) 110 may be tuned to different frequencies to avoid interference. In at least one embodiment the communications module 160 transmits information concerning the accommodation state of the contact lens. In other embodiments the communications module 160 may transmit other information including sensor data, a request for sensor data, a request for confirmation of data interpretation (e.g., direction of focus and/or contact lens orientation), data interpretation, an instruction to perform a function such as with the actuator and/or a predefined function, etc.

In at least one embodiment as illustrated in FIG. 5D, the contact lens 100C includes the system controller 130 having a register 134 for storing data samples from the ultrasound module 110. In a further embodiment, there is an individual register for each ultrasound module 110 and/or a receiving transducer present on the contact lens 100C. The use of a register 134 in at least one embodiment allows for the comparison of data with prior data, a threshold, a preset value, a calibrated value, a target processing value, or a template with or without a mask. Such a comparison could be between two different amplitude versus time responses represented by different data series (or signal) of reflected sound pressure wave(s) detected by the ultrasound module 110 in response to emitted sound pressure waves. In an alternative embodiment, other data storage is used instead of a register(s). In an alternative embodiment, the register 134 is part of the data storage 132.

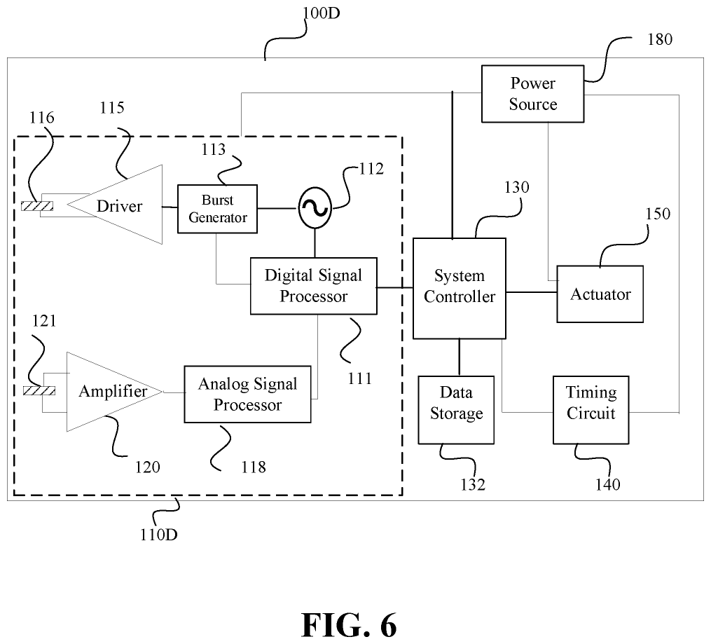

FIGS. 6-11 and 15 illustrate different ultrasound modules that illustrate different transmit paths and receive paths examples of paths that facilitate transmitting and receiving sound pressure waves from one or more transducers 116, 121 that start or end with a processor 111 and/or the system controller 130 depending on the example embodiment.

FIG. 6 illustrates a contact lens 100D that includes an ultrasound module 110D having distinct transmit and receive sides (or paths), which may be implemented in the other embodiments, to the ultrasound module 110D. In at least one alternative embodiment, the transmit transducer and the receive transducer are combined into a transceiver configured to both transmit and receive communications and share common circuitry. The illustrated ultrasound module 110D includes a digital signal processor 111, an oscillator 112, a burst generator 113, a transmit driver 115, a transmit ultrasound transducer 116, an analog signal processor 118, a receive amplifier 120, and a receive ultrasound transducer 121. In at least one alternative embodiment for the ultrasound module 110D, the digital signal processor 111 is combined with the system controller 130. In another alternative embodiment, the analog signal processor 118 is combined with the digital signal processor 111 and/or replaced with an analog-to-digital convertor as illustrated in a later figure. These two alternative embodiments may be combined to provide a further alternative embodiment along with be used in other embodiments.

The digital signal processor 111 receives a control signal from the system controller 130. In at least one embodiment, the digital signal processor 111 includes a resettable counter and a time-to-digital convertor and transmit/receive sequencing controls. The oscillator 112 in at least one embodiment is a switched oscillator. In at least one embodiment, the frequency of the oscillator 112 is programmable through a preset oscillator value, the system controller or external interface. The frequency can be tuned using a reference oscillator and an external interface. In at least one further embodiment, the frequency is set or tuned to a value that minimizes transmit and receive electrical power and allows the transmit ultrasound transducer 116 to produce a pressure sound wave that will have maximum amplitude at the receiver input. In a more particular embodiment, the oscillator 112 is a programmable frequency oscillator such as a current starved ring oscillator where the current and the capacitance control the oscillation frequency where the frequency can be altered by changing the current supplied to the oscillator. In at least one embodiment, the wavelength of the sound pressure wave is tuned based on the dimensions of the transducer used. In a further embodiment, the oscillator 112 varies over time for optimal transmission characteristics. In a still further embodiment, the frequency is calibrated using a reference frequency provided through an external interface and an automatic frequency control (AFC) circuit. The frequency is preset with the AFC tuning it. The frequency can be directly set through the serial interface, which can be accessed through the external communications link.

In an embodiment where the time of flight is used, the counter in the digital signal processor 111 begins to count pulses output from the oscillator 112. The burst generator 113 gates the oscillator signal for a fixed amount of time defined as the burst length. In at least one embodiment, the burst length is programmable or determined by static timing relationships within the burst generator 113.

The output voltage of the burst generator 113 may be level shifted to the appropriate value for the transmit driver 115 and the transmit ultrasound transducer 116. An example of the transmit ultrasound transducer 116 is a piezoelectric device which converts applied burst voltage to a sound pressure wave. In at least one embodiment, the sound pressure wave includes a burst or multiple sound pressure waves. In a further embodiment, the transmit ultrasound transducer 116 is made of any piezoelectric material that is compatible with the power source and the physical properties of the contact lens. Another example of a transducer is a polyvinylidene fluoride or polyvinylidene difluoride (PVDF) film. The sound pressure wave produced by the transmit ultrasound transducer 116 propagates from the contact lens 100D into the eye. The distance to the ciliary muscle and/or the lens can be measured by dividing the travel time between the propagation of the sound pressure wave and receipt of the reflected sound pressure wave by the receive ultrasound transducer 121 multiplied by the speed of sound in the eye as discussed previously.

The receive amplifier 120 and the analog signal processor 118 in at least one embodiment are turned on with the oscillator 112 or turned on after a predetermined delay after the oscillator 112 is started. When there is a predetermined delay, power for contact lens 100D operation may be lowered during the period of delay. In an embodiment where the receive amplifier 120 and the analog signal processor 118 are started with the oscillator 112, the receive amplifier 120 will receive an output from the receive ultrasound transducer 121 proximate to when the sound pressure wave is output by the transmit ultrasound transducer 116. This output from the receive ultrasound transducer 121 can be used to reset the counter in the digital signal processor 111. In a further embodiment, the detection of the transmit sound pressure wave can be used as an indicator that a true transmit signal has been generated.

A sound pressure wave received by the receive ultrasound transducer 121 will produce a voltage signal with a frequency, amplitude, and burst length properties related to the transmitted sound pressure wave. The voltage signal is amplified by the receive amplifier 120 before being sent to the analog signal processor 118, which in an alternative embodiment to embodiments having the receive amplifier 120 and the signal processor 118 are combined into a signal processor. The analog signal processor 118 may include, but is not limited to, frequency selective filtering, envelope detection, integration, level comparison and/or analog-to-digital conversion. Based on this disclosure, it should be appreciated that these functions may be separated into individual blocks with some examples being illustrated in later figures. The analog signal processor 118 produces a received signal that represents the received sound pressure wave at the receive ultrasound transducer 121, which in implementation will have a slight delay. The received signal is passed from the analog signal processor 118 to the digital signal processor 111. When transmission time is used, the digital signal processor 111 will stop the counter that is counting pulses from the oscillator 112 when the received signal is received. In such an embodiment, the measured time can be compared to a predetermined value to determine whether a change in focus should occur. In other embodiments, the digital signal processor 111 interprets the received signal for a message from, for example, the other contact lens or an external device. The resulting output from the digital signal processor 111 is provided to the system controller 130. In an alternative embodiment, the counter does not stop so that a series of received sound pressure waves may be detected to develop a representation of an amplitude versus time set of data for analysis by, for example, the system controller 130. This alternative embodiment may also be used in connection to other embodiments in this disclosure.

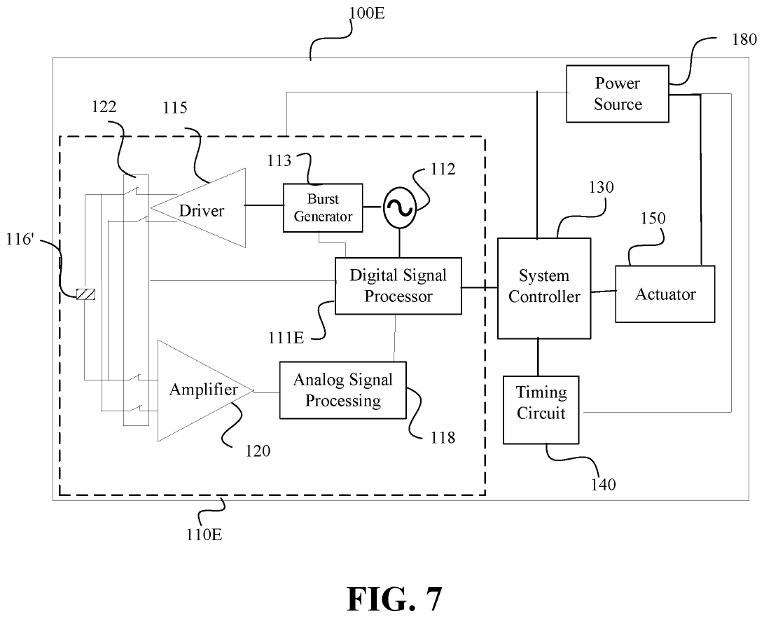

FIG. 7 illustrates a contact lens 100E with an ultrasound module 110E. The illustrated ultrasound module 110E includes one ultrasound transducer 116′ that is shared by the transmit and receive sides. The single ultrasound transducer 116′ is multiplexed between transmit and receive operation through use of a switch 122. The digital signal processor 111E uses the output of the burst generator 113 to switch the transducer 116′ to transmit mode by connecting the transmit driver 115 to the transducer 116′. When the burst is completed, then the digital signal processor 111E switches the switch 122 to the receive mode by connecting the receive amplifier 120 to the transducer 116′. One advantage to this configuration is that the transducer area is reduced from two transducers to one transducer, but a drawback to this configuration is that a short time of flight may not be detected or if the ultrasound module is being used for communication, then a received communication may be missed during a transmission or vice versa. The remaining components of the illustrated embodiment remain the same from the prior embodiment.

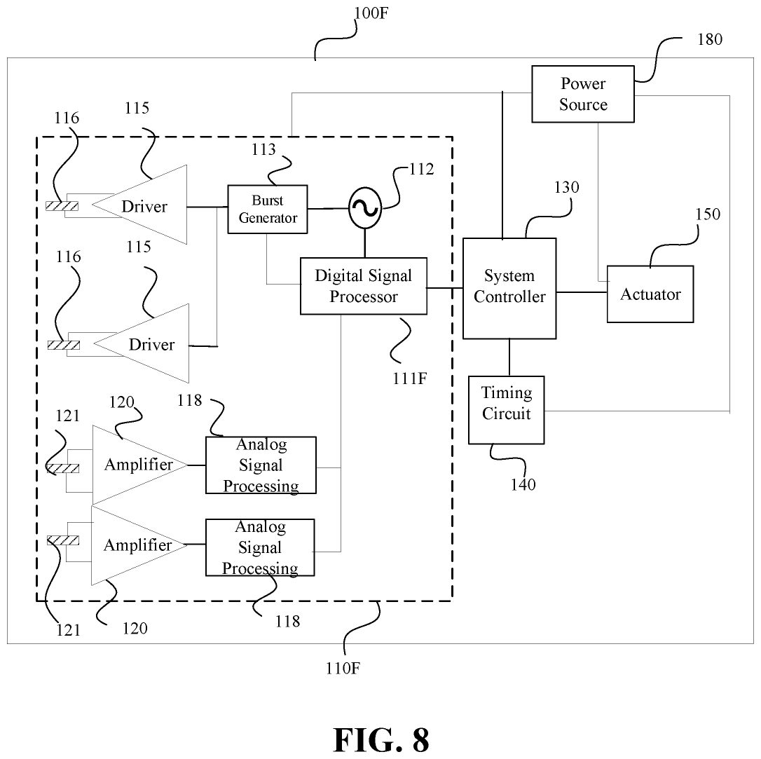

FIG. 8 illustrates a contact lens 100F with an ultrasound module 110F with a transmit side that includes two transmit paths and a receive side that includes two receive paths. One advantage to this configuration is that the transducers may be aimed at different areas of the ciliary muscle and/or the lens to provide two different measurements, but in an alternative approach this can be accomplished by having multiple ultrasound modules. The two transmit paths as illustrated share the oscillator 112 and the burst generator 113, but in an alternative embodiment the transmit paths may have dedicated oscillators 112 and burst generators 113. Each of the receive paths include a receive ultrasound transducer 121 electrically connected to a receive amplifier 120, which is electrically connected to an analog signal processor 118. The analog signal processors 118 are electrically connected to the digital signal processor 111F.

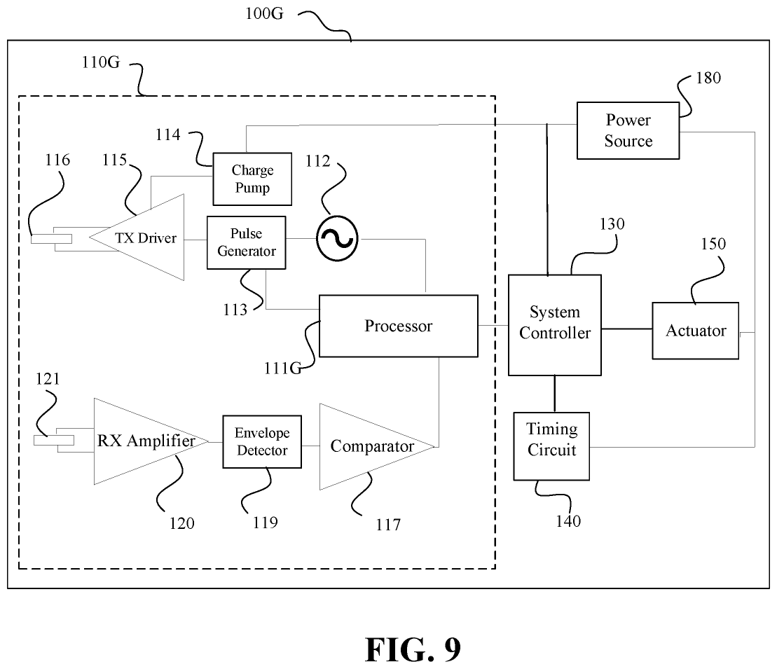

FIG. 9 illustrates a contact lens 100G with an ultrasound module 110G. The illustrated ultrasound module 110G includes a processor 111G, the oscillator 112, the pulse generator 113, a charge pump 114, the transmit driver 115, the transmit ultrasound transducer 116, a comparator 117, an envelope detector 119, the receive amplifier 120, and the receive ultrasound transducer 121. The charge pump 114 is electrically connected to the power source 180 and to the transmit driver 115, which provides a voltage to the transmit ultrasound transducer 116 to create the sound pressure wave to be emitted by the transducer 116. In at least one embodiment, the transmit driver 115 includes an inverter or an H-bridge, and in further embodiments includes an output driver circuit. In at least one embodiment, the charge pump 114 increases the voltage through the relationship between charge and capacitance with voltage by increasing the charge on a capacitance component(s) (e.g., a capacitor). The voltage output from the charge pump 114, in at least one embodiment, is used as the supply voltage to the transmit driver 115. The transmit driver 115 switches between the output of the charge pump 114 and ground in an alternating fashion in response to the input from the pulse generator 113 to produce an alternating voltage. The alternating voltage is applied by the driver 115 to polarize the material of the transducer 116 in one direction and then the other direction to create a mechanical stress causing the material to be displaced in a specific direction (i.e. the direction the transducer is facing). The displacement of the transducer material coupled with the shape and the size of the transducer produce the sound pressure wave. Thus, the larger the applied voltage is to the transducer, the larger the stress and thus the larger the displacement and associated sound pressure wave.

The charge pump 114 is also electrically connected to the processor 111G, which controls operation of the charge pump 114 in at least one embodiment to minimize power consumption by the system by, for example turning off the oscillator 112, the pulse generator 113, and/or the charge pump 114 at times when the ultrasound module 110G does not need to propagate a sound pressure wave. The envelope detector 119 turns the high-frequency output of the receive ultrasound transducer 121 into a new signal that provides an envelope signal representative of the original output signal to be provided to the comparator 117. This illustrated embodiment has the advantage of simplifying the analysis of the output of the receive ultrasound transducer 121 to determine if a particular threshold has been met for the contact lens 100G to perform a function. The comparator 117 provides an output to the processor 111G, which is in electrical communication with the system controller 130.

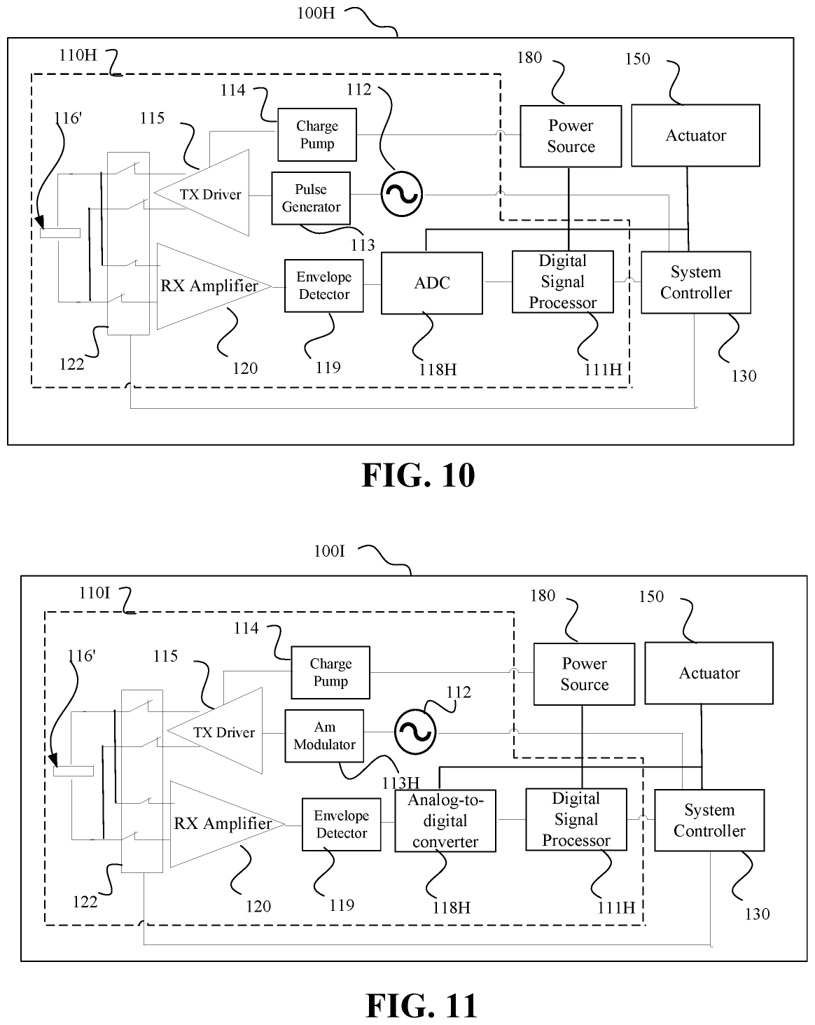

FIG. 10 illustrates a contact lens 100H with an ultrasound module 110H. The illustrated ultrasound module 110H includes a digital signal processor 111H, the oscillator 112, the pulse generator 113, the charge pump 114, the transmit driver 115, the transmit/receive ultrasound transducer 116′, an analog-to-digital converter (ADC) 118H, an envelope detector 119, the receive amplifier 120, and the switch 122. The ADC 118H converts the output from the envelope detector 119 into a digital signal for the digital signal processor 111H.

FIG. 11 illustrates a contact lens 100I with an ultrasound module 110I. The illustrated ultrasound module 110I includes a digital signal processor 111H, the oscillator 112, an amplitude modulation (AM) modulator 1131, the charge pump 114, the transmit driver 115 such as a transmit amplifier, the transmit/receive ultrasound transducer 116′, an analog-to-digital converter (ADC) 118H, an envelope detector 119, the receive ultrasound transducer 121, and the switch 122. In the illustrated embodiment, the charge pump 114, the AM modulator 1131 and transmit driver 115 act as the level shifter and the burst generator. The AM modulator 1131 in this embodiment is controlled by the digital signal processor 111H. The circuit works where the oscillator signal is provided to the AM modulator 1131, which in at least one embodiment is an AND gate, and the digital signal processor 111H provides a second clock at a frequency much lower than the oscillator frequency. The output of the circuit is then a sequence of pulses that occur during the positive cycle of the lower frequency. The transmit driver 115 has the appropriate gain to output the modulated signal at the charge pump voltage thus providing level shifting.

Based on the disclosure connected to FIGS. 9-11, one of ordinary skill in the art should appreciate that the different ultrasound module configurations and transducer/switch configurations may be interchanged and mixed together in different combinations.

FIG. 12 illustrates a contact lens 1200 with an electronic insert 1204 having an ultrasound module. The contact lens 1200 includes a soft plastic portion 1202 which houses the electronic insert 1204, which in at least one embodiment is an electronics ring around a variable lens 1206. This electronic insert 1204 includes the variable lens 1206 which is activated by the electronics, for example focusing near or far depending on activation (or accommodation level). In at least one embodiment, the electronic insert 1204 omits the adjustability of the lens 1206. Integrated circuit 1208 mounts onto the electronic insert 1204 and connects to batteries (or power source) 1210, the variable lens 1206, and other components as necessary for the system.

In at least one embodiment, a transmit ultrasound transducer 1212 and a receive ultrasound transducer 1213 are present in the ultrasound module. In at least one embodiment, the integrated circuit 1208 includes a transmit ultrasound transducer 1212 and a receive ultrasound transducer 1213 with the associated signal path circuits. The transducers 1212, 1213 face inward through the lens insert and toward the eye (i.e., inward-facing or ciliary muscle-facing), and is thus able to send sound pressure waves toward the wearer's ciliary muscle and/or lens and detect at least the partially reflected waves. In at least one embodiment, the transducers 1212, 1213 are fabricated separately from the other circuit components in the electronic insert 1204 including the integrated circuit 1208. In this embodiment, the transducers 1212, 1213 may also be implemented as separate devices mounted on the electronic insert 1204 and connected with wiring traces 1214. Alternatively, the transducers 1212, 1213 may be implemented as part of the integrated circuit 1208 (not shown). Based on this disclosure one of ordinary skill in the art should appreciate that transducers 1212, 1213 may be augmented by the other sensors.

FIG. 13 illustrates another contact lens 1200′ with an electronic insert 1204′ having an ultrasound module. The contact lens 1200′ includes a soft plastic portion 1202 which houses the electronic insert 1204′. This electronic insert 1204′ includes the variable lens 1206 which is activated by the electronics, for example focusing near or far depending on activation (or accommodation level). In at least one embodiment, the electronic insert 1204′ omits the adjustability of the lens 1206. Integrated circuit 1208 mounts onto the electronic insert 1204′ and connects to batteries (or power source) 1210, the variable lens 1206, and other components as necessary for the system. The ultrasound module includes a transmit/receive ultrasound transducer 1212′ with the associated signal path circuits. The transducer 1212′ faces inward through the lens insert and towards, for example, the iris of the eye, and is thus able to send and receive sound pressure waves. As discussed above, the transducer 1212′ may be fabricated separately from the other electronic components prior to mounting on the electronic insert 1204 or alternatively implemented on the integrated circuit 1208 (not shown). The transducer 1212′ may also be implemented as a separate device mounted on the electronic insert 1204′ and connected with wiring traces 1214. Based on this disclosure one of ordinary skill in the art should appreciate that transducer 1212′ may be augmented by the other sensors.

In a further embodiment to the embodiments illustrated in FIGS. 12 and 13, the integrated circuit 1208, the power source 1212 and the transducers 1212, 1212′, 1213 are present in an area of the contact lens contained in an overmold, which is a material (such as plastic or other protective material) encapsulating the electronic insert 1204. In at least one further embodiment, the overmold encapsulates the ultrasound module(s).

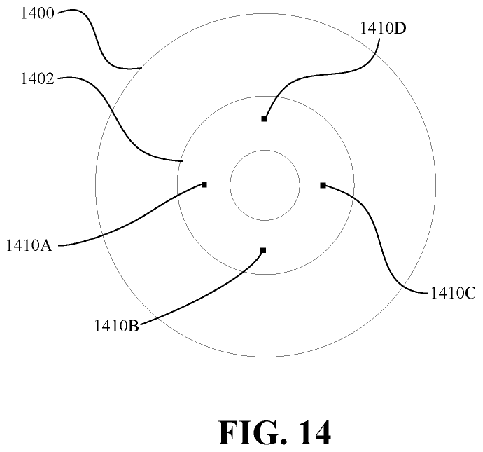

In at least one embodiment as illustrated in FIG. 14 (omits the other components to facilitate presentation clarity), there are a plurality of ultrasound modules 1410A-1410D spaced around the contact lens 1402 on the eye 1400 to increase the number of transducers aimed at the ciliary muscle and/or the lens. Although four ultrasound modules 1410A-1410D are illustrated, it should be appreciated based on this disclosure that a variety of numbers of ultrasound modules may be used with example numbers of ultrasound modules being any number between 2-8, a plurality of ultrasound modules, and at least one ultrasound module. The illustrated ultrasound modules 1410A-1410D are evenly spaced around the periphery of the contact lens 1402 where evenly spaced includes equal distance between the ultrasound modules (i.e., the same distance between neighboring ultrasound modules) and/or balanced about a diameter drawn through the contact lens 1402.

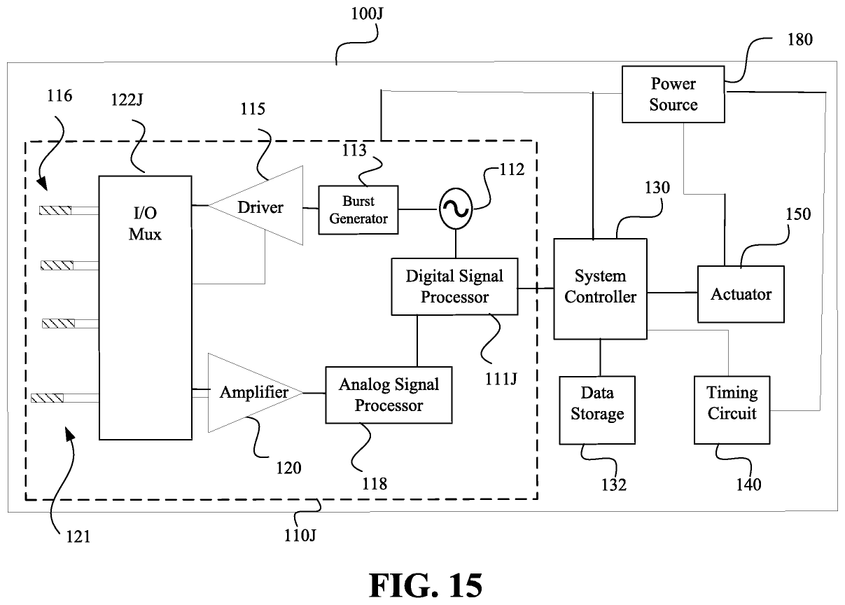

In at least one embodiment, the system controller deactivates the transmission components of the ultrasound module when the respective contact lens is not transmitting. In a further embodiment, the illustrated ultrasound modules are replaced by transducers that are multiplexed together as illustrated in FIG. 15. In a further embodiment where there are a plurality of ultrasound modules or at least a plurality of transmit/receive/transceiver transducers, the method includes having the system controller determine which ultrasound module/transducer provides the best response. The system controller selects the ultrasound module/transducer that produces a highest output response to received sound pressure waves. The system controller will deactivate the ultrasound module(s)/transducer(s) that were not selected (i.e., provided a lower signal strength).

In an alternative embodiment illustrated in FIG. 15, the contact lens 100J has one ultrasound module 110J having a plurality of transducers 116, 121 and an I/O multiplexer (mux) 122J attaching the transducers 116, 121 to the ultrasound module components discussed in the above embodiments. FIG. 15 illustrates the inclusion of the digital signal processor 111J, the oscillator 112, the burst generator 113, the driver 115, the amplifier 120, and the analog signal processor 118. In alternative embodiment, these ultrasound module components may be replaced by components from the other described ultrasound module embodiments including using just the transmit or receive paths of those embodiments. An advantage of this configuration is that it reduces the power requirements and weight considerations by eliminating duplicative components and allowing the ultrasound module to drive multiple transmit transducers and to receive analog signals from multiple receive transducers. In at least one embodiment, the transmit transducers and the receive transducers are distributed about the contact lens as discussed above in connection with FIG. 14. In a further embodiment, the transmit transducers and the receive transducers are grouped together in one area of the contact lens.

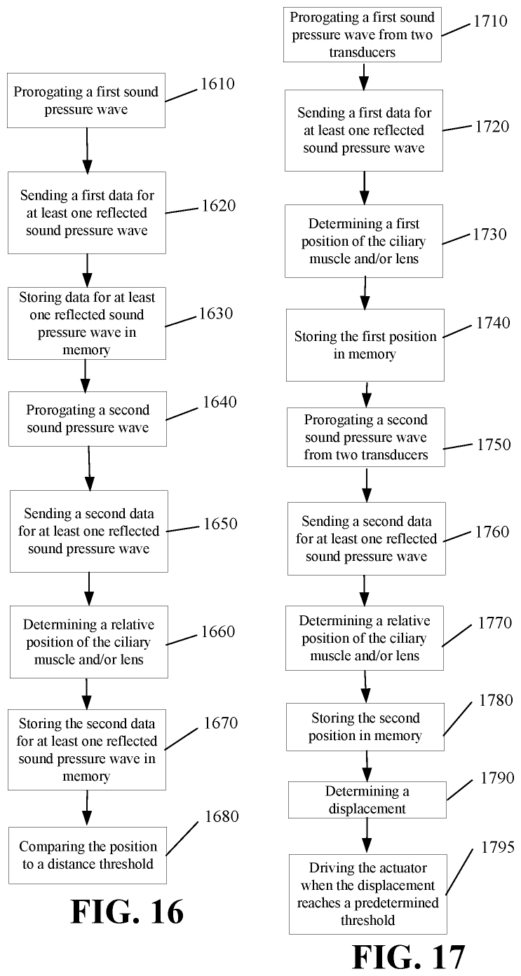

FIG. 16 illustrates a method that may be used with more than one of the above-described system embodiments. The illustrated method provides an example of how imaging of a wearer's lens or ciliary muscle may be achieved using an embodiment of the contact lens system described herein. The contact lens is configured to measure the distance displaced by the lens and/or the ciliary muscle during accommodation based on the orientation of the transmit ultrasound transducer of the ultrasound module. For certain orientations of the transmit ultrasound transducer, the propagated sound pressure wave is emitted from the contact lens into the eye and toward a fixed position such that when the lens is accommodated, the sound pressure wave is partially reflected by the ciliary muscle and/or the lens. For other orientations of the transmit ultrasound transducer, the propagated sound pressure wave is not reflected by the ciliary muscle and travels through the lens. FIGS. 1A-2B and 3A-4B provide example illustrations of these configurations. The distance from the contact lens to either the ciliary muscle or the boundary of the lens is determined, for example, from 1) the relationship of the sound pressure wave time of flight to the speed of sound in the eye or 2) a comparison of two data series of reflected sound pressure waves to determine a displacement and/or other changes. In an alternative embodiment, a relaxed (or accommodated) data series is stored as a template by the system to compare future data series against. The relaxed (or accommodated) data series is determined in at least one embodiment based on a detection of an accommodated (or relaxed) state compared to the relaxed (or accommodated) data series.

The ultrasound module propagates a first sound pressure wave at a predetermined frequency towards the ciliary muscle and/or the lens, 1610. The ultrasound module transmits at least one detection of a reflected sound pressure wave to the first sound pressure wave by the transducer, 1620. The reflected sound pressure wave time, amplitude, and/or frequency (or detected reflected data) is recorded in memory (or data storage) by the system controller, 1630. The ultrasound module propagates a second sound pressure wave at a predetermined frequency towards the ciliary muscle and/or the lens, 1640. In at least one embodiment, the frequency is used for the second sound pressure wave is different than the frequency used for the first sound pressure wave. The ultrasound module transmits at least one second detection of a reflected sound pressure wave to the second sound pressure wave by the transducer, 1650.

The processor determines a relative position of the wearer's ciliary muscle and/or lens based on the relationship between at least part of the at least one detected reflected data for the first and the second sound pressure waves, 1660. An alternative embodiment uses the relationship of the first time of flight and the second time of flight to a constant, e.g. speed of sound in the eye, 1660. The system controller overwrites the first detected reflected data in the memory with the second detected reflected data, or alternatively stores the second detected reflected data, 1670. The relationship is compared to a threshold (e.g., a distance threshold if a position is being used) and the system controller drives the actuator when the position reaches a predetermined threshold, 1680. In at least one embodiment, the predetermined threshold corresponds to distance displaced by a ciliary muscle during accommodation. In at least one further embodiment, the predetermined threshold corresponds to distance displaced by a lens during accommodation. In at least one further embodiment, the predetermined threshold corresponds to a distance displaced by a lens having presbyopia. In an alternative embodiment, the system controller stores the shortest and/or longest times of flight or a representation of these to measure the differential from and to compare to the predetermined threshold. In another alternative embodiment, the system controller stores the shortest and/or longest detected reflected data based on the time between the first and the last relevant reflection detected by the ultrasound module where in at least one embodiment the last relevant reflection is for the target of the sound pressure wave.

In other embodiments, the ultrasound module includes at least two transmit/receive paths and the method steps are performed simultaneously or contemporaneously to image at least two distinct points, a first point along the boundary of the ciliary muscle and a second point on the boundary of the lens. It should be understood by one skilled in the art that increasing the number of data points imaged enhances overall resolution, and additional ultrasound transducers and/or transceivers may be included to achieve this result.

In an alternative embodiment to the method illustrated in FIG. 16, the first sound pressure wave and the second sound pressure wave are propagated at a predetermined sampling interval. An advantage of this embodiment is detecting real-time displacement of the ciliary muscle and/or the lens to further enhance imaging. Power conservation advantages are also derived from this configuration.

FIG. 17 illustrates an alternative method that may be used with more than one of the above-described system embodiments wherein the ultrasound module includes at least two transducers. The ultrasound module propagates a first sound pressure wave from each of the two transducers of the ultrasound module towards the ciliary muscle and/or the lens, 1710. The ultrasound module transmits a data signal representing at least one detected reflected sound pressure wave (e.g., time, amplitude, and/or frequency) at each of the two transducers, 1720. The processor determines a first position of the ciliary muscle and/or the lens based on the relationship of the detected reflected data such as comparing a first time of flight (of the reflected sound pressure wave of the target, e.g., P1, P2, P3, and P4) to a constant representing the speed of sound in the eye, 1730. The first position is stored in memory (or data storage), 1740. The ultrasound module propagates a second sound pressure wave from each of the two transducers of the ultrasound module towards the ciliary muscle and/or the lens, 1750. The ultrasound module transmits a data signal representing the second detected reflected data produced by each of the two transducers, 1760. The processor determines a second position of the ciliary muscle and/or the lens based on the relationship of the detected reflected data such as comparing a second time of flight (of the reflected sound pressure wave of the target, e.g., P1, P2, P3, and P4) to a constant representing the speed of sound in the eye, 1770. The second position is stored in memory, 1780. The processor determines a displacement from the difference between the first position and the second position, 1790. The system controller drives the actuator when the displacement reaches a predetermined threshold, 1795. In an alternative embodiment, the displacement may be determined based on the time between two reflected sound pressure waves such as the discussion associated with FIGS. 2C and 2D previously in this disclosure.

In a further alternative embodiment, the system controller determines a relative position, shape, and/or state of the target (e.g., P1, P2, P3, and P4) at which the sound pressure waves are being aimed.

In at least one embodiment, the system analysis a series of times of flight (or detected reflected data) with a time-frequency analysis to detect patterns that may be present. In a further embodiment, the system will record the series of times of flight (or detected reflected data series) for later downloading and/or analysis external to the contact lens.

In at least one embodiment, the system will send a series of chirps across a frequency range to create a data set to subject to time-frequency analysis looking for patterns and/or selecting a frequency that provides the strongest data response. In a further embodiment, the frequency sweep will occur at predetermined intervals to allow for the selected frequency to be adjusted akin to frequency hopping and/or to provide additional data sets for time-frequency analysis. In a further embodiment to either of these two embodiments, the detected pattern from the time-frequency analysis is compared to a template representing accommodation and/or non-accommodation. When the detected pattern matches a template and it indicates a change in accommodation, then adjusting the level of accommodation for the contact lens.

One approach to facilitate communication between a first and a second contact lens is to implement automatic frequency control for the communication channel. In at least one embodiment, the timing circuit on one contact lens would be the master. The clock synchronization in at least one embodiment will lead the electronics to be biased towards a lens pair to have one be a master. In a further embodiment, the selection of the master contact lens is made after manufacturing via a software and/or identification tag download to the lenses and/or settings change. This approach also could be used to facilitate the dual frequency approach discussed in this disclosure.

In an alternative embodiment to the methods illustrated in FIGS. 16 and 17, the first contact lens is the master and the second contact lens is the subordinate. A binary marker is recorded in memory where 1 corresponds to accommodation. The communications module on each lens establishes a communications protocol. The communications module on the first lens transmits a message encoding the binary accommodation indicator to the second lens. The system controller on the second lens drives the actuator when the received binary accommodation indicator is 1.

In a further embodiment, the communications module is tuned to a different frequency than any frequency used by the at least one ultrasound module. An advantage of this is that it improves each receiver's capability of correctly detecting the desired signal. By using separate frequencies, frequency selective techniques (such as mixing and envelope detection) can reject noise or undesired transmit signals that could be produced by the physical geometry and properties of the communication channel through scattering on the nose.

Although shown and described in what is believed to be the most practical embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. An ophthalmic lens configured for imaging of a wearer's eye including an iris, a ciliary muscle and/or a lens, the ophthalmic lens comprising:
at least one ultrasound module including at least two transducers orientated such that when a sound pressure wave is propagated, the sound pressure wave travels towards the wearer's ciliary muscle and/or the lens and oriented to receive sound pressure waves reflected from the ciliary muscle and/or the lens;
a system controller in electrical communication with said at least one ultrasound module, said system controller configured to provide at least one control signal to said at least one ultrasound module and receive at least one corresponding data signal from said at least one ultrasound module, and said controller configured to determine a relative position, shape, and/or state of the wearer's ciliary muscle and/or lens based on data signals produced by said at least one ultrasound module in response to at least one received sound pressure wave;
an actuator in electrical communication with said system controller configured to perform a function in response to at least one control signal from said system controller; and
a timing circuit in electrical communication with said system controller.

2. The ophthalmic lens system according to claim 1, further comprising memory in communication with said system controller and/or said actuator;
wherein said actuator is configured to store data based on each sample taken in said memory.

3. The ophthalmic lens system according to claim 1, further comprising a communications module in electrical communication with said system controller.

4. The ophthalmic lens according to claim 1, further comprising a power source in electrical communication with said system controller and said timing circuit.

5. The ophthalmic lens according to claim 1, further comprising a data storage in electrical communication with the system controller, said data storage storing preset values.

6. The ophthalmic lens according to claim 1, wherein said at least one ultrasound module includes a plurality of ultrasound modules distributed around said ophthalmic lens.

7. The ophthalmic lens according to claim 1, wherein said at least two transducers is four transducers and includes a first transmit transducer, a second transmit transducer, a first receive transducer, and a second receive transducer.

8. The ophthalmic lens system according to claim 1, wherein each ultrasound module includes
a processor in electrical communication with said system controller;
a first transceiver and a second transceiver, each transceiver having
a switch in electrical communication with said processor;
at least one transmit path having
an oscillator in electrical communication with said processor,
a burst generator in electrical communication with said oscillator and said processor,
a transmit driver in electrical communication with said burst generator configured to receive a burst signal from said burst generator, said transmit driver drives one of said two transducers when connected through said switch; and
at least one receive path having
a receive amplifier in electrical communication with said one of at least two transducers through said switch and configured to amplify an output of said one of said two transducers,
an analog signal processor in communication with said receive amplifier and said processor; and
wherein said processor configured to control said switch and an operation mode of said ultrasound module between transmit and receive.

9. The ophthalmic lens system according to claim 8, wherein each transceiver is tuned to different frequencies.

10. The ophthalmic lens of claim 1, wherein one of said at least two transducers in said at least one ultrasound module is configured to transmit and receive the sound pressure wave at a frequency in a range of 5 to 20 MHz.

11. The ophthalmic lens of claim 1, wherein one of said at least two transducers in said at least one ultrasound module is configured to transmit and receive the sound pressure wave at a frequency above 20 MHz.

12. The ophthalmic lens of claim 1, wherein the ophthalmic lens is a contact lens.

13. A method of imaging an eye to detect lens accommodation using an ophthalmic lens having at least one ultrasound module having at least one transducer and a processor configured to perform a clock function, a system controller in electrical communication with the at least one ultrasound module, and a memory in electrical communication with the system controller, the method comprising:
propagating into the eye a first sound pressure wave at a predetermined frequency by one of the at least one transducer of the ultrasound module;
transmitting a first data signal to the system controller representing a time, an amplitude, and/or a frequency of at least one first received sound pressure wave detected by at least one of the at least one transducer of the ultrasound module;
recording the first data signal in the memory by the system controller;
propagating into the eye a second sound pressure wave at a predetermined frequency by one of the at least one transducer of the ultrasound module;
transmitting a second data signal to the system controller a time, an amplitude, and/or a frequency of at least one second received sound pressure wave detected by at least one of the at least one transducer of the ultrasound module;
setting a position distance based on the relationship of the difference between the first data signal and the second data signal;
storing the second data signal by the system controller in memory;
comparing the position distance to a distance threshold by the system controller.

14. The method according to claim 13, further comprising driving an actuator when the position distance reaches the distance threshold correlating to distance displaced by a ciliary muscle during accommodation.

15. The method according to claim 13, further comprising driving an actuator when the position distance reaches the distance threshold correlating to distance displaced by a lens during accommodation.

16. The method according to claim 13, further comprising propagating the first sound pressure wave and the second sound pressure wave at a predetermined sampling interval.

17. The method according to claim 13, further comprising analyzing a series of times of flight in the data signals with time-frequency analysis.

18. A method of imaging an eye to detect accommodation using an ophthalmic lens system including a first ophthalmic lens and a second ophthalmic lens, each ophthalmic lens having at least one ultrasound module having two transducers tuned to different frequencies and a processor configured to perform a clock function, a system controller in electrical communication with the communications module and the at least one ultrasound module, and a data storage in electrical communication with the system controller, the method comprising:
propagating into the eye a first sound pressure wave at a predetermined frequency by each of the two transducers of the ultrasound module;
transmitting a first data signal to the system controller representing a time, an amplitude, and/or a frequency of at least one first received sound pressure wave detected by each of the two transducers of the ultrasound module based in part on a signal from the timing circuit;
setting a first position from the relationship of the first data signal using a predefined constant;
recording the first position in the data storage;
propagating into the eye a second sound pressure wave at a predetermined frequency by each of the two transducers of the ultrasound module;
transmitting a second data signal to the system controller representing a time, an amplitude, and/or a frequency of at least one received sound pressure wave detected by each of the two transducers of the ultrasound module by the timing circuit;
setting a second position from the relationship of the second data signal using the predefined constant;
recording said second position in the data storage;
determining a displacement based on the difference between the first position and the second position; and
driving the actuator when the displacement reaches a predetermined threshold.

19. The method according to claim 18, wherein the predetermined threshold correlates to an eye having presbyopia.

20. The method according to claim 18, wherein the first ophthalmic lens is a master and the second ophthalmic lens is a subordinate, each ophthalmic lens includes a communications module, the method further comprising:
setting a binary accommodation indicator in the data storage on the first lens where 1 corresponds to accommodation;
establishing a communications link between the communications modules on the ophthalmic lenses;
transmitting a message encoding the binary accommodation indicator by the communications module on the first ophthalmic lens;
decoding the received message by the communications module on the second ophthalmic lens; and
driving the actuator on the second ophthalmic lens when the received binary accommodation indicator equals 1.
